(19) United States
(12) Patent Application Publication
(10) Pub. No.: US 2026/0260827 A1
(43) Pub. Date: Sep. 3, 2026

(54) SWITCH DEVICE AND SWITCH MODULE

(71) Applicant: Alps Alpine Co., Ltd., Tokyo (JP)

(72) Inventors: Weijun QIN, WUXI (CN); Min WU, WUXI (CN); Xunyu ZHANG, WUXI (CN); Jiuhua ZUO, WUXI (CN)

(21) Appl. No.: 19/549,530

(22) Filed: Feb. 25, 2026

(30) Foreign Application Priority Data
Feb. 28, 2025 (CN) 202510231226.0

(51) Int. Cl. H01H 13/06; H01H 13/14

(52) U.S. Cl. CPC H01H 13/06; H01H 13/14

(57) ABSTRACT

A switch device is provided, including: an operating member having an operating portion for a push-in operation and a placement portion on which a movable contact is placed; a housing accommodating the placement portion and having a through hole through which the operating portion is exposed; a return member configured to return the operating member to its original position; a plurality of fixed contacts fixed in the housing; and the movable contact provided on the placement portion. Each of the plurality of fixed contacts has a conduction portion accommodated in the housing and a plurality of external terminals exposed from the housing, and a waterproof platform is provided on a bottom surface side of the housing opposite to the operating portion so as to enclose roots of the plurality of external terminals and protrude in a direction away from the operating portion along an extending direction of the external terminals.

### CLAIM OF PRIORITY

This application claims benefit of Chinese Patent Application No. 202510231226.0 filed on February 28, 2025, which is hereby incorporated by reference.

### BACKGROUND OF THE INVENTION

### 1. Field of the Invention

The present invention relates to a switch device and a switch module including the switch device.

### 2. Description of the Related Art

According to an existing switch device (see Chinese Registered Utility Model CN202712006), a conduction state between fixed contacts and a movable contact is switched by pushing an operating portion at a top of an operating member. On a housing of the switch device, a pair of parallel external terminals protrudes downward from a bottom surface. The pair of external terminals outputs, via a wiring substrate, signals indicating the conduction state externally. In a related art of the switch device, to prevent water from entering between the pair of external terminals and causing short circuits between the terminals, the pair of external terminals is sealed together with the wiring substrate on a side where the pair of external terminals is located using thermoplastic molding.

Although the structure of the above switch device satisfies the waterproof performance test standard known as IP67 (i.e., immersion at a depth of 1 m underwater for 30 mins), it cannot satisfy the more stringent requirements of HINZ waterproof test. The HINZ waterproof test requires placing the device at a high temperature of 90°C for 30 mins followed by immersion in a 5% saline solution for 5 mins. Under such conditions, short circuits between the terminals of the switch device may occur. Analysis suggests that thermal expansion and contraction may occur at a joint between the bottom surface of the housing and a sealing member, allowing water to seep into through a gap at the joint. When water reaches between the pair of external terminals, a short circuit occurs between the terminals.

To meet waterproof requirements under more stringent conditions, there is a need to design a switch device with improved waterproof performance.

### SUMMARY OF THE INVENTION

In view of the above issues, the present invention is made to provide a switch device having excellent waterproof performance and a switch module including such a switch device.

A switch device in technical solution 1 includes: an operating member having an operating portion for a push-in operation and a placement portion on which a movable contact is placed; a housing accommodating the placement portion of the operating member and having a through hole through which the operating portion of the operating member is exposed; a return member configured to return the operating member to its original position; a plurality of fixed contacts fixed in the housing; and the movable contact provided on the placement portion of the operating member. A conduction state between the movable contact and the plurality of fixed contacts is switched by movement of the operating member. Each of the plurality of fixed contacts has a conduction portion accommodated in the housing and a plurality of external terminals exposed from the housing; and a waterproof platform is provided on a bottom surface side of the housing, i.e., a side that is opposite to the operating portion so as to enclose roots of the plurality of external terminals and protrude in a direction away from the operating portion along an extending direction of the external terminals.

According to technical solution 1, by providing a waterproof platform that encloses the roots of the external terminals, a creepage distance between the two external terminals may be increased. Accordingly, short circuits between the external terminals may be less likely to occur even if water penetrates from the bottom surface side of the housing.

In the switch device in technical solution 2, the waterproof platform may include a plurality of anchor portions that are provided at positions corresponding to the plurality of external terminals on the bottom surface side of the housing and protrude in the direction away from the operating portion so as to enclose an outer periphery of each of the plurality of external terminals.

According to technical solution 2, by providing a plurality of anchor portions that enclose the outer periphery of each of the plurality of external terminals, the creepage distance between the two external terminals may be increased. Accordingly, short circuits between the external terminals may be less likely to occur even if water penetrates from the bottom surface side of the housing.

In the switch device in technical solution 3, the waterproof platform may include a stepped portion that is provided on the bottom surface side of the housing and protrudes in the direction away from the operating portion so as to cover a central portion of an outer bottom surface of the housing and enclose the roots of the external terminals; and a plurality of anchor portions that are provided at positions corresponding to the plurality of external terminals and protrude from the stepped portion in the direction away from the operating portion so as to enclose an outer periphery of each of the plurality of external terminals.

According to technical solution 3, by providing a stepped portion and a plurality of anchor portions provided at a bottom surface side of the stepped portion, the creepage distance between two external terminals may be increased. Short circuits between the external terminals may be less likely to occur even if water penetrates from the bottom surface side of the housing.

In the switch device in technical solution 4, the waterproof platform may further include a blocking portion provided between the plurality of anchor portions, and the blocking portion may protrude in the direction away from the operating portion along the extending direction of the external terminals.

According to technical solution 4, by providing a blocking portion between the plurality of anchor portions, the creepage distance between the two external terminals may be further increased, further enhancing the waterproof performance of the switch device.

In the switch device in technical solution 5, each of the plurality of anchor portions may be formed with a plurality of sections along the extending direction of the external terminals, and each of the plurality of anchor portions may have a middle section with a cross-sectional area smaller than that of each of two end sections of the plurality of anchor portions along a planar direction parallel to the bottom surface of the housing.

According to technical solution 5, the bonding strength between the anchor portion and a thermoplastic molded sealing member provided outside the anchor portion may be improved, increasing the creepage distance between the two external terminals and further enhancing the waterproof performance of the switch device.

In the switch device in technical solution 6, the blocking portion may be formed with a plurality of sections along the extending direction of the external terminals, and the blocking portion may have a middle section with a cross-sectional area smaller than that of each of two end sections of the blocking portion along a planar direction parallel to the bottom surface of the housing.

According to technical solution 6, the bonding strength between the blocking portion and a thermoplastic molded sealing member provided outside the blocking portion may be improved, increasing the creepage distance between the two external terminals and further enhancing the waterproof performance of the switch device.

In the switch device in technical solution 7, a bottom-surface area of the housing may be greater than that of the stepped portion, and the bottom-surface area of the stepped portion may be greater than those of the anchor portion and the blocking portion.

In the switch device in technical solution 8, the housing may include a frame body having an opening at a lower side and a bottom plate fitted to the opening; the plurality of fixed contacts may be integrally fixed to the bottom plate by insert molding; and the bottom plate and the waterproof platform may be formed from a same resin material.

According to technical solution 8, since the bottom plate and the waterproof platform may be formed from the same material, they can be molded using a single mold. For example, the fixed contacts can be secured to the bottom plate by curing while the fixed contacts are inserted into the mold. As a result, no gap may exist between the external terminals of the fixed contacts and the waterproof platform, making it difficult for water to seep into the interior of the switch device even if water penetrates from the bottom surface side of the housing. Additionally, forming the bottom plate and the waterproof platform from a resin material, compared to using metal materials, can generate greater bonding strength when joining with the thermoplastic sealing member.

In the switch device in technical solution 9, the housing may include a frame body having an opening at an upper side and a cover plate fitted to the opening; the plurality of fixed contacts may be integrally fixed to the frame body by insert molding; and the frame body and the waterproof platform may be formed from a same resin material.

According to technical solution 9, since the frame body and the waterproof platform may be formed from the same resin material, they can be molded using a single mold. For example, the fixed contacts can be secured to the frame body by curing while the fixed contacts are inserted into the mold. As a result, no gap may exist between the external terminals of the fixed contacts and the waterproof platform, making it difficult for water to seep into the interior of the switch device even if water penetrates from the bottom surface side of the housing. Additionally, forming the frame body and the waterproof platform from a resin material, compared to using metal materials, can generate greater bonding strength when joining with the thermoplastic sealing member.

In the switch device in technical solution 10, three switch devices may be arranged in parallel; the external terminals of each switch device may output, via a shared wiring substrate, detection signals indicating switching of the conduction state externally; and the waterproof platform, the external terminals, and the shared wiring substrate may be enclosed by a thermoplastic molded sealing member.

According to technical solution 10, the detection signals indicating switching of the conduction state can be output to the outside while maintaining excellent waterproof performance.

A switch module in technical solution 11 includes three switch devices according to any one of technical solutions 1 to 3 arranged in parallel. The external terminals of each switch device output, via a shared wiring substrate, detection signals indicating switching of the conduction state externally; and the waterproof platform, the external terminals, and the shared wiring substrate are enclosed by a thermoplastic molded sealing member.

According to technical solution 11, the detection signals indicating switching of the conduction state can be output to the outside while maintaining excellent waterproof performance.

### BRIEF DESCRIPTION OF THE DRAWINGS

FIG. 1 is a front view of a switch device according to Embodiment 1;

FIG. 2 is an exploded perspective view of the switch device according to Embodiment 1;

FIG. 3 is an exploded perspective view illustrating an operating member, a movable contact, a return member, and fixed contacts;

FIG. 4A is a perspective view illustrating an assembled state of a bottom plate, a waterproof platform, and the fixed contacts; FIG. 4B is a top view of FIG. 4A;

FIG. 5 is a cross-sectional view taken along line V–V of FIG. 4B;

FIG. 6 is a bottom view of FIG. 4A;

FIG. 7 is a schematic view of Modification 1 of the switch device according to Embodiment 1;

FIG. 8 is a schematic view of Modification 2 of the switch device according to Embodiment 1; and

FIG. 9A and FIG. 9B are perspective views of Modification 3 of the switch device according to Embodiment 1; FIG. 9A illustrates three switch devices arranged in parallel and connected to a shared wiring substrate; and FIG. 9B illustrates a sealing member formed by thermoplastic molding around an outside of the three switch devices and the wiring substrate.

### DESCRIPTION OF THE PREFERRED EMBODIMENTS

### Embodiment 1

A switch device of Embodiment 1 includes: an operating member having an operating portion for a push-in operation and a placement portion on which a movable contact is placed; a housing accommodating the placement portion of the operating member and having a through hole through which the operating portion of the operating member is exposed; a return member configured to return the operating member to its original position; a plurality of fixed contacts fixed in the housing; and the movable contact disposed on the placement portion of the operating member. A conduction state between the movable contact and the plurality of fixed contacts is switched by movement of the operating member. Each of the plurality of fixed contacts has a conduction portion accommodated in the housing and a plurality of external terminals exposed from the housing; and on a bottom surface side of the housing, i.e., a side that is opposite to the operating portion, a waterproof platform is provided so as to enclose roots of the plurality of external terminals and protrude in a direction away from the operating portion along an extending direction of the external terminals.

Below, the switch device of Embodiment 1 will be described with reference to the accompanying drawings.

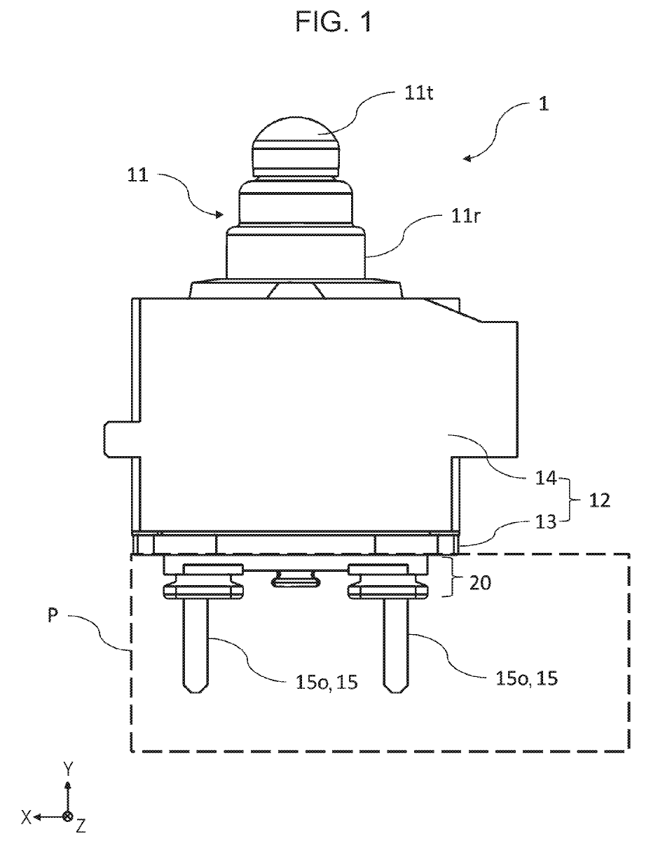

FIG. 1 is a front view of a switch device 1 of Embodiment 1, illustrating the switch device 1 observed when the operating member is in a non-operated state. In the following description, a Y-direction in FIG. 1, i.e., an extending direction of the operating member, is referred to as an up-and-down direction; an X-direction in FIG. 1, i.e., an arrangement direction of the lead terminals, is referred to as a left-and-right direction; and a Z-direction, which is perpendicular to both the up-and-down and left-and-right directions, is referred to as a depth direction. It should be noted that the aforementioned up-and-down, left-and-right, and depth directions are used merely for convenience of explanation and may differ from the actual orientation during use.

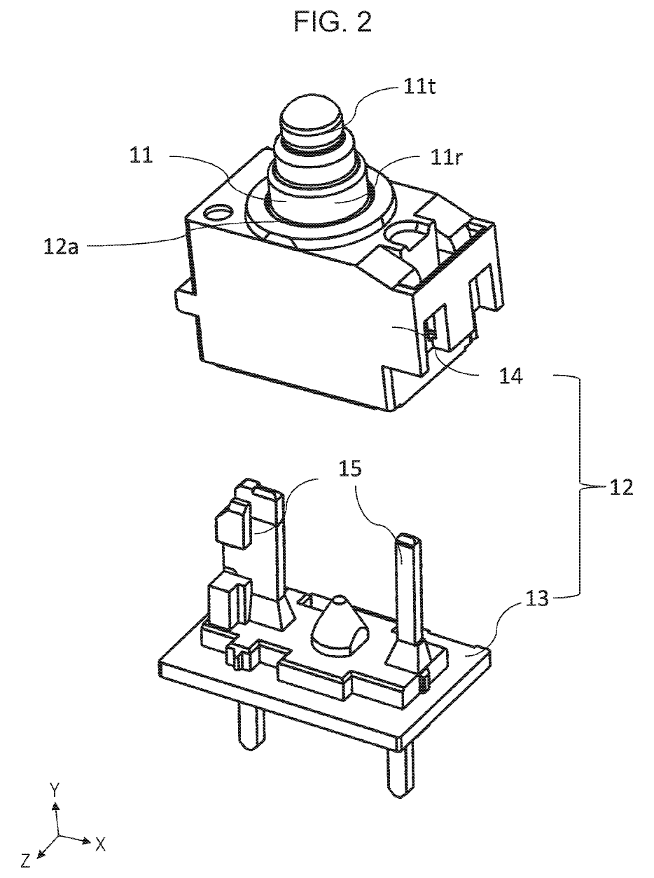

As shown in FIGS. 1 and 2, a housing 12 includes a frame body 14 having an opening at a lower side and a bottom plate 13 fitted to the opening. The frame body 14 is configured to protect an operating member 11 and includes an internal guiding structure that restricts a movement direction of the operating member 11. Additionally, a through hole 12a is formed at a center of an upper surface of the frame body 14 to allow an operating portion 11t of the operating member 11 to be exposed. The bottom plate 13 is formed from an insulating material, such as a resin material, and is tightly joined to the frame body 14, making it difficult for water to seep into the interior of the housing 12 from a joint between the bottom plate 13 and the frame body 14.

The operating member 11 extends along the Y-direction and includes the operating portion 11t as its upper portion, a sleeve 11r that can be fitted over the operating portion 11t, and a placement portion 11k as its lower portion, where the placement portion 11k is not shown in FIGS. 1 and 2. The operating portion 11t, with the sleeve 11r fitted over it, protrudes upward through the through hole 12a provided on the upper surface of the frame body 14, thereby being exposed from the frame body 14.

Below the housing 12 in FIG. 1, a waterproof platform 20, a pair of external terminals 15o as a part of the fixed contacts 15, and a sealing member P indicated by a dashed-line frame are also shown. The fixed contacts 15 are integrally fixed to the bottom plate 13 through insert molding. The part of the fixed contacts 15 exposed outside the housing 12 is referred to as the external terminals 15o, which serve as lead terminals for outputting the conduction state of the switch device 1 externally. The extending direction of the fixed contacts 15 (external terminals 15o) is perpendicular to a plane of the bottom plate 13. Although the figure shows a pair of fixed contacts 15, the number of fixed contacts 15 is not limited to this configuration. The waterproof platform 20 is provided close to an end portion of the external terminals 15o that meets a bottom surface of the housing 12, enclosing outer peripheries of the external terminals 15o. Furthermore, during actual use of the switch device 1, the external terminals 15o below the housing 12 and the wiring connected to them are sealed through thermoplastic molding. This ensures that a lower surface of the housing 12 closely contacts the sealing member formed by thermoplastic molding, achieving insulation and waterproof. The illustration of the sealing member and other components connected to the external terminals 15o is omitted here, with only the position of the sealing member P schematically indicated.

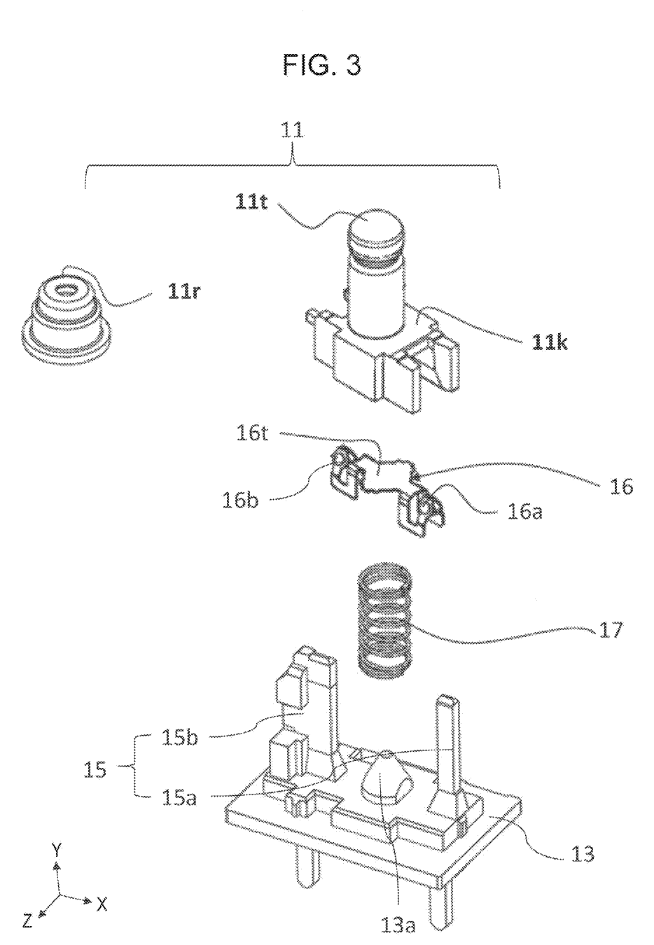

FIG. 3 is an exploded perspective view showing a part of the switch device 1 with components arranged from top to bottom as follows: the operating member 11, a movable contact 16, a return member 17, and a combined assembly of the fixed contacts 15 and the bottom plate 13.

As shown in FIG. 3, the operating member 11 includes the operating portion 11t as its upper portion, the placement portion 11k as its lower portion, and the sleeve 11r. In FIG. 3, the operating portion 11t and the sleeve 11r are separated and depicted as two distinct components. However, this configuration is not restrictive; the operating member 11 may alternatively include only the operating portion 11t, which is exposed from the housing 12, and the placement portion 11k, which is accommodated in the housing 12. The placement portion 11k is formed as a generally horseshoe-shaped recess capable of accommodating the movable contact 16, and a top surface 16t of the movable contact 16 may be fixed to an inner top surface of the placement portion 11k by means such as riveting.

The movable contact 16 is a curved, elastic conductive metal plate, including the flat top surface 16t and a pair of elastic wall portions 16a and 16b, each located on a corresponding side of the flat top surface 16t to face each other.

On the bottom plate 13, a mounting portion 13a for mounting the return member 17 is formed at a position between the fixed contacts 15 arranged along the X-direction and opposing the return member 17. The return member 17 is sandwiched between the mounting portion 13a of the bottom plate 13 and the top surface 16t of the movable contact 16. When the operating member 11 is pressed, a compression force generated by compressing the return member 17 enables the operating member 11 to return to its original position.

The pair of fixed contacts 15 are rod-shaped conductive metal rods formed on the bottom plate 13 at positions opposing the pair of elastic wall portions 16a and 16b of the movable contact 16. Based on whether they remain continuously connected to the movable contact 16, the pair of fixed contacts 15 can be classified into a shared fixed contact 15a and a switching fixed contact 15b. The shared fixed contact 15a is configured to establish connection with the movable contact 16 earlier than the switching fixed contact 15b. As an example, as shown in FIG. 3, a tip of the shared fixed contact 15a may be positioned higher than that of the switching fixed contact 15b.

In a non-pressed state (i.e., when the operating member 11 is not in the operated position), the elastic wall portion 16a of the movable contact 16 is connected to the shared fixed contact 15a of the fixed contacts 15, while the elastic wall portion 16b of the movable contact 16 is separated from the switching fixed contact 15b of the fixed contacts 15 and located above it. In this state, the pair of fixed contacts are not electrically connected.

In a pressed state (i.e., when the operating member 11 is in the operated position), the elastic wall portion 16a of the movable contact 16 remains connected to the shared fixed contact 15a of the fixed contacts 15, and the elastic wall portion 16b of the movable contact 16 also is connected to the switching fixed contact 15b of the fixed contacts 15. In this state, the pair of fixed contacts become electrically connected.

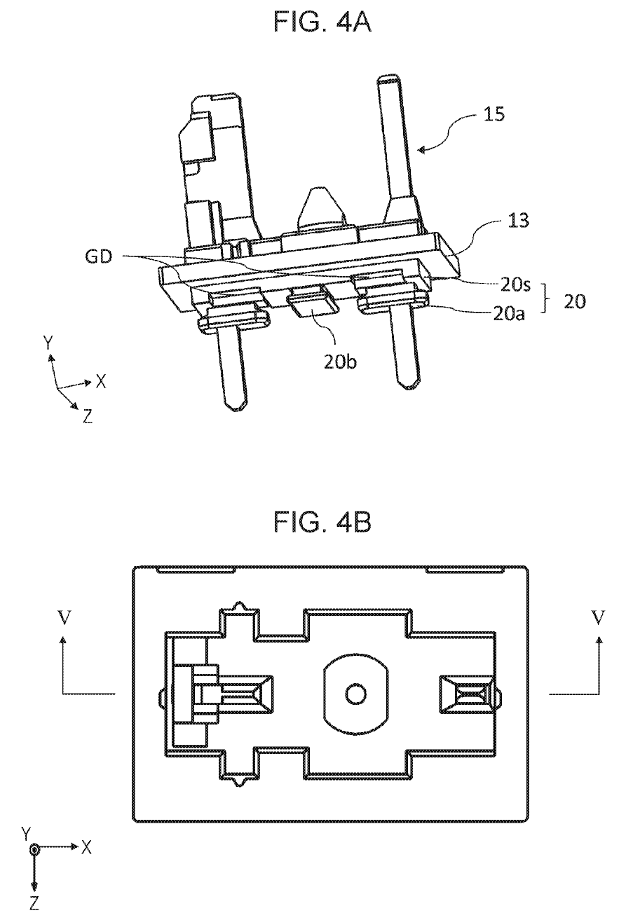

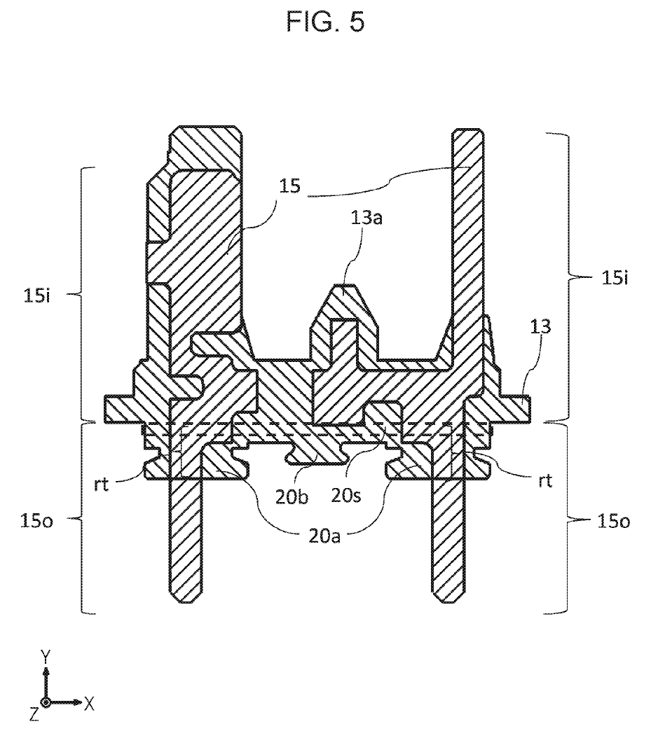

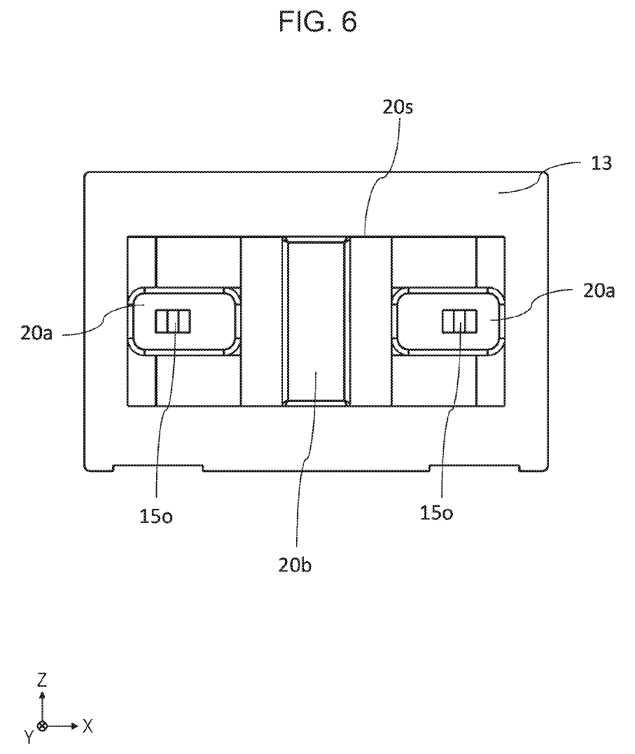

FIG. 4A is a perspective view illustrating an assembled state of the bottom plate 13, the waterproof platform 20, and the fixed contacts 15 of the switch device 1; and FIG. 4B is a top view illustrating the assembled state of the bottom plate 13, the waterproof platform 20, and the fixed contacts 15 of the switch device 1. FIG. 5 is a cross-sectional view taken along line V–V of FIG. 4B. FIG. 6 is a bottom view illustrating the assembled state of the bottom plate 13, the waterproof platform 20, and the fixed contacts 15 of the switch device 1.

As shown in FIG. 5, the fixed contacts 15 not only can be classified into the shared fixed contact 15a and the switching fixed contact 15b arranged along the X-axis direction by whether they remain continuously connected to the movable contact 16, but also can be classified into conduction portions 15i accommodated in the housing 12 and the external terminals 15o exposed outside the housing 12 along the Y-axis direction by whether they are exposed outside the housing 12. Functionally, the conduction portions 15i are a part of the fixed contact 15 that can come into contact with or separate from the movable contact 16 as the operating member 11 moves back and forth, while the plurality of external terminals 15o are a part of the fixed contact 15 that outputs detection signals indicating switching of the conduction state to the outside.

In FIG. 5, a part of a lower portion of each of the conduction portions 15i, which is fixedly connected to the bottom plate 13, is provided with a multi-serpentine structure and a protrusion structure. In Embodiment 1, these complex shapes are used for insert molding to achieve a reliable connection between the bottom plate 13 and the fixed contacts 15. However, it is not limited to the above method. For example, simpler shapes could also be used, with reliable connections achieved by means such as welding.

As shown in FIGS. 4A to 6, the bottom plate 13 in Embodiment 1 is formed as a square-like plate when viewed in plan. On a bottom surface side of the bottom plate 13, i.e., the side opposite to where the operating portion 11t is located, a waterproof platform 20 is provided so as to enclose outer peripheries of roots rt of the external terminals 15o and protrude downward, i.e., in a direction away from the operating portion 11t. Here, the roots rt refer to the part of the external terminals 15o that extends from the bottom plate 13 and is relatively closer to the bottom plate 13.

The waterproof platform 20 includes a stepped portion 20s, anchor portions 20a, and a blocking portion 20b, each protruding away from the operating portion 11t. The stepped portion 20s, indicated by the dashed box in FIG. 5, is located on the bottom surface side of the bottom plate 13, and protrudes away from the operating portion 11t so as to cover a central portion of the bottom plate 13 and enclose a part of the roots rt of the external terminals 15o. Additionally, the span of the stepped portion 20s along the X-direction is greater than the distance between the two anchor portions 20a arranged along the X-direction. The anchor portions 20a are provided on a bottom surface side of the stepped portion 20s, at positions corresponding to the plurality of external terminals 15o. They protrude away from the operating portion 11t so as to enclose the outer periphery of each of the plurality of external terminals 15o. In Embodiment 1, since there are two external terminals 15o, only two anchor portions 20a are provided. However, if the number of external terminals 15o is three or more, the number of anchor portions 20a can also be three or more, as long as the number of anchor portions 20a corresponds to the number of external terminals 15o.

The blocking portion 20b is provided on the bottom surface side of the stepped portion 20s and between the plurality of anchor portions 20a. When there are two anchor portions 20a symmetrically arranged on both sides in the X-direction, the blocking portion 20b is positioned approximately at the central portion of the bottom plate 13. When the plurality of anchor portions 20a are arranged to form a polygon, the blocking portion 20b should be provided between each pair of anchor portions 20a. Furthermore, in FIG. 5, end sides of the anchor portions 20a and the blocking portion 20b away from the stepped portion 20s (lower end sides in the figure) are arranged at intervals along the X-direction. End sides of the anchor portions 20a and the blocking portion 20b close to the stepped portion 20s are shown connected in the X-direction, but they may also be unconnected. Between each anchor portion 20a, and between each anchor portion 20a and the blocking portion 20b, recesses are formed that extend from their respective bottom surfaces toward the bottom surface side of the housing 12. The anchor portions 20a and the blocking portion 20b are not formed on the same flat plane, thereby increasing a creepage distance between the external terminals 15o. Additionally, in FIG. 5, outer side surfaces of the anchor portions 20a are shown to be flush with an outer side surface of the stepped portion 20s, but the outer side surfaces of the anchor portions 20a may also not be aligned with the outer side surface of the stepped portion 20s.

In addition, the stepped portion 20s, the anchor portions 20a, and the blocking portion 20b each has a bottom surface parallel to the bottom plate 13. A bottom-surface area of the bottom plate 13 is greater than that of the stepped portion 20s, and the bottom-surface area of the stepped portion 20s is greater than those of the anchor portions 20a and the blocking portion 20b. By forming the plurality of parallel bottom surfaces, the contact area between the sealing member P and each bottom surface is increased, thereby enhancing the bonding strength of the sealing member P. Moreover, forming the bottom plate 13, the stepped portion 20s, the anchor portions 20a, and the blocking portion 20b from a resin material can also improve the bonding strength between these components and the sealing member P. Furthermore, although the bottom surfaces of the stepped portion 20s, the anchor portions 20a, and the blocking portion 20b are all rectangular in Embodiment 1, their shapes are not limited to this and may take other forms.

By providing a waterproof platform of a certain thickness on a lower portion of the bottom plate 13 to enclose the external terminals 15o as described above, even if water seeps into a gap between a lower surface of the bottom plate 13 and the sealing member P, the extended water penetration path reduces the likelihood of water contacting the external terminals 15o. Even if contact occurs, the contact area can be minimized, thereby decreasing the possibility of short circuits between the two external terminals 15o.

In addition, the waterproof platform of a certain thickness can be designed as a multi-section structure with non-uniform widths. In Embodiment 1, the anchor portions 20a and the blocking portion 20b are designed as a multi-section structure, resembling, for example, a sandwich configuration. As shown in FIG. 5, for example, the anchor portions 20a and the blocking portion 20b are formed with a necking structure where the widths at upper and lower ends are greater than that at a center along the extending direction of the external terminals 15o. Additionally, although not illustrated, a cross-sectional area of each of two end sections of the anchor portions 20a and the blocking portion 20b is smaller than that of each of the middle sections thereof along a planar direction parallel to the bottom surface of the housing 12 (in Embodiment 1, the bottom surface of the bottom plate 13). The three-section structure of the anchor portions 20a and blocking portion 20b mentioned above is merely an example, and other multi-section structures are also possible.

By adopting the above structure, the creepage distance of water moving along the surface of the resin material can be further increased. In other words, when water bridges the two external terminals 15o, a short circuit will occur between them. Increasing the creepage distance of water moving along the resin surface reduces the likelihood of such a short circuit. Additionally, with the anchor portions 20a and the blocking portion 20b each having the necking structure, the bonding strength between these components and the sealing member P is enhanced, making it more difficult for water to penetrate. Furthermore, it is also possible to include only the anchor portions 20a while the blocking portion 20b is omitted.

In addition, in Embodiment 1, the bottom plate 13 and the waterproof platform 20 are formed from the same resin material and are integrally formed using a single mold. For example, with the fixed contacts 15 inserted into the mold, the resin material is cured to secure the fixed contacts 15 onto the bottom plate 13 and the waterproof platform 20. As a result, no gap exists between the external terminals 15o of the fixed contacts 15 and the waterproof platform 20. Even if water penetrates from the bottom surface side of the housing 12, it is difficult for the water to seep into the interior of the switch device 1. Additionally, by forming the bottom plate 13 and the waterproof platform 20 from a resin material, compared to using metal materials, stronger bonding strength can be achieved when joining with the thermoplastic sealing member P.

In addition, as shown in FIG. 4A, a guide portion GD for guiding water flow may also be provided on the waterproof platform 20, generally located at a certain position along the extending path of the external terminals 15o. The guide portion GD includes one or more grooves. Additionally, the guide portion GD may also be formed on a part of the bottom of the housing 12. As an example, a first groove can be formed on a part of the bottom of the housing 12 (in Embodiment 1, the bottom of the bottom plate 13), and a second groove can be formed on a part of the waterproof platform 20. The second groove and the first groove are generally located along the extending path of the external terminals 15o. In this case, even if water penetrates from the gap between the bottom surface of the housing 12 and the sealing member P, it is more likely to flow downward along the extending direction of the external terminals 15o, reducing the possibility of forming a short-circuit path along the arrangement direction of the two external terminals 15o.

### Modification 1

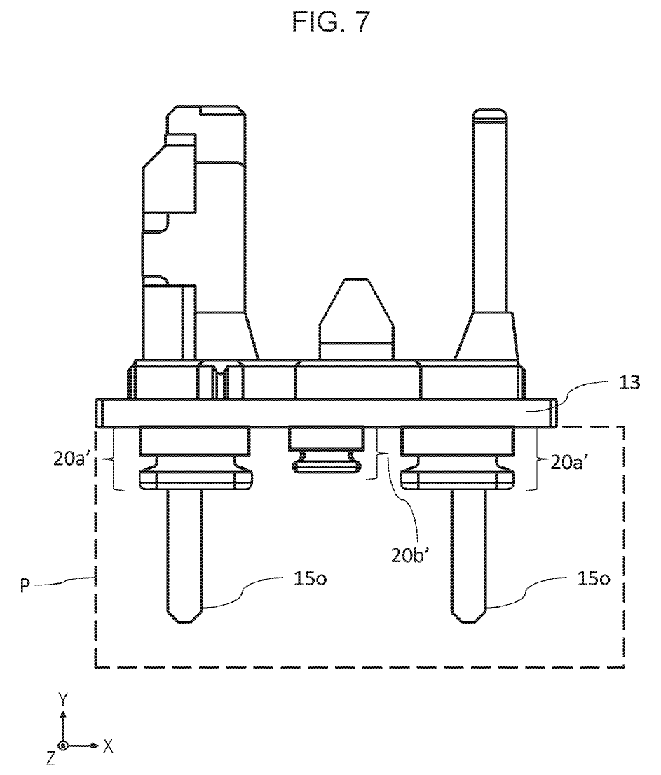

FIG. 7 is a schematic view of Modification 1 of the switch device 1 according to Embodiment 1.

Modification 1 differs from Embodiment 1 in that the waterproof platform 20 includes anchor portions 20a' and a blocking portion 20b', with no stepped portion included in Modification 1. Other aspects of the configuration are identical to those of Embodiment 1, and redundant descriptions are omitted.

According to the structure of Modification 1, a waterproof platform (anchor portions 20a' and blocking portion 20b') of a certain thickness is also provided on the lower portion of the bottom plate 13 to enclose the external terminals 15o. The anchor portions 20a' are provided on the bottom plate 13 at positions corresponding to the external terminals 15o, enclosing the outer peripheries of the external terminals 15o. The blocking portion 20b' is provided between a plurality of anchor portions 20a'. The anchor portions 20a' and the blocking portion 20b' are arranged at intervals along the X-direction. As a result, even if water penetrates from the gap between the lower surface of the bottom plate 13 and the sealing member P, the extended water penetration path reduces the likelihood of water contacting the external terminals 15o. Even if contact occurs, the contact area can be minimized, thereby decreasing the possibility of short circuits between the two external terminals 15o.

In addition, both the anchor portions 20a' and the blocking portion 20b' are formed as a multi-section structure, resembling, for example, a sandwich configuration. A cross-sectional area of each of the middle sections of the anchor portions 20a' and the blocking portion 20b' is smaller than that of each of two end sections thereof along a planar direction parallel to the bottom surface of the housing 12 (in Embodiment 1, the bottom surface of the bottom plate 13).

By adopting the above structure, the creepage distance of water moving along the surface of the resin material can be further increased. Additionally, with the anchor portions 20a' and the blocking portion 20b' each having a necking structure, the bonding strength between these components and the sealing member P is enhanced, making it more difficult for water to penetrate. Similarly, in this Modification, only the anchor portions 20a' may be included while the blocking portion 20b' is omitted.

### Modification 2

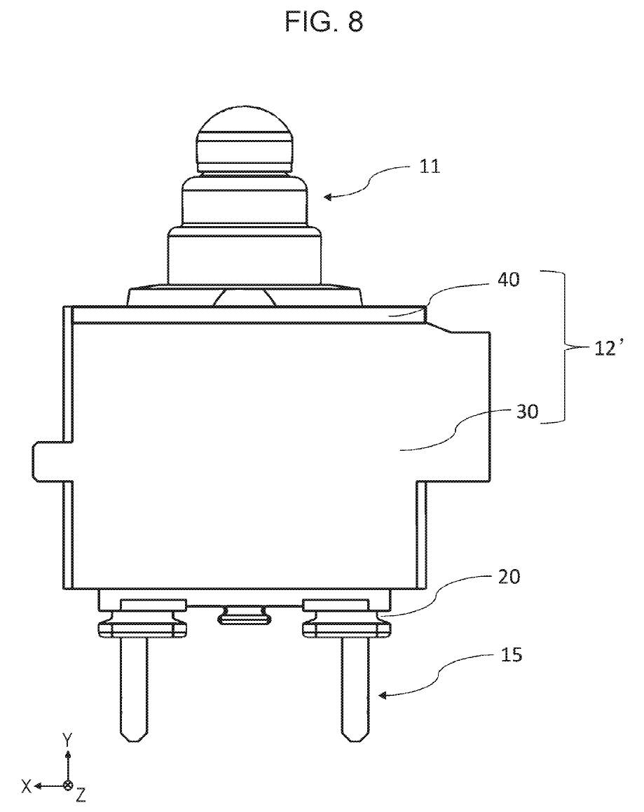

FIG. 8 is a schematic view of Modification 2 of the switch device 1 according to Embodiment 1.

In Embodiment 1 and Modification 1, the housing 12 includes a frame body 14 having an opening at a lower side and a bottom plate 13 fitted to the opening. In contrast, in Modification 2, as shown in FIG. 8, a housing 12' may alternatively be configured to include a frame body 30 with an opening at an upper side and a cover plate 40 fitted to the opening. The cover plate 40 is provided with a through hole through which the operating member 11 extends. In Modification 2, the frame body 30 and the waterproof platform 20 are formed from the same resin material and are integrally formed using a single mold. With the fixed contacts 15 inserted into the mold, the resin material is cured to secure the fixed contacts 15 onto the frame body 30 and the waterproof platform 20. As a result, no gap exists between the external terminals 15o of the fixed contacts 15 and the frame body 30 and the waterproof platform 20, making it difficult for water to seep into the interior of the switch device 1 even if water penetrates from the bottom surface side of the housing 12' (bottom surface side of the frame body 30).

Other aspects of the structure of Modification 2 are substantially the same as those of Embodiment 1. Regarding the waterproof platform 20, Modification 2 may adopt either the same structure as Embodiment 1 or the same structure as Modification 1. Consequently, Modification 2 can achieve the same effects as Embodiment 1 or Modification 1.

### Modification 3

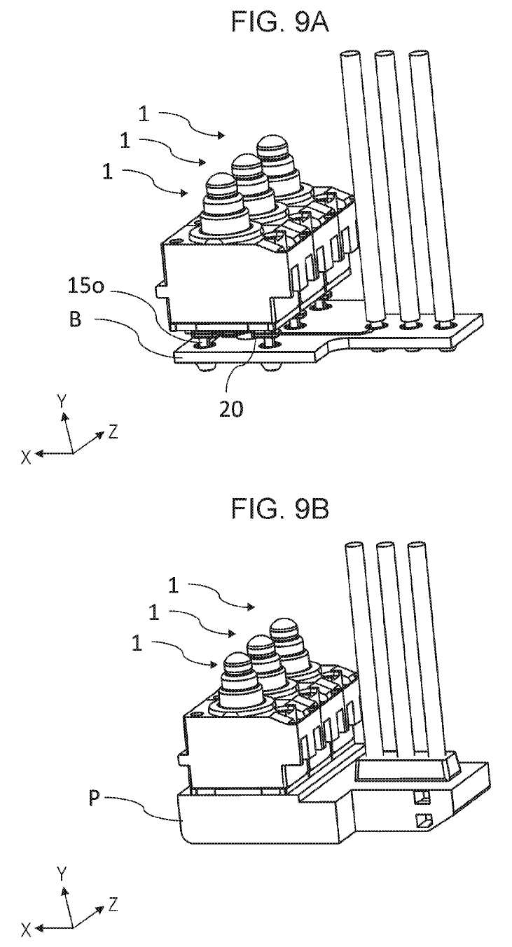

FIG. 9A and FIG. 9B are perspective views of Modification 3 of the switch device 1 according to Embodiment 1; FIG. 9A illustrates three switch devices 1 arranged in parallel and connected to a wiring substrate B; and FIG. 9B illustrates a sealing member P formed by thermoplastic molding around an outside of the three switch devices 1 and the wiring substrate B.

Below, an example usage scenario of the switch device 1 is described. The structure and effects of the switch device 1 may align with any of Embodiment 1, Modification 1, or Modification 2. In Modification 3, three switch devices 1 are connected in parallel as detectors to monitor three states of a vehicle door (non-contact, contact, open). Each switch device 1 corresponds to one door state. The external terminals 15o of each switch device 1 output, via the shared wiring substrate B, detection signals indicating switching of the conduction state to the outside, thereby enabling detection of changes in the three door states. Additionally, to ensure the insulation and waterproof of the external terminals 15o, the waterproof platform 20, the external terminals 15o, and the shared wiring board B are enclosed by a thermoplastic sealing member P. An upper surface of the sealing member P is tightly bonded to the bottom surface of the housing.

The above descriptions are the case of combining independent switch devices, but it is also possible to design three parallel-connected switch devices as a single switch module.

That is, a switch module includes three switch devices arranged in parallel. The external terminals of each switch device output, via a shared wiring substrate, detection signals indicating switching of the conduction state to the outside. The waterproof platform, the external terminals, and the shared wiring substrate are enclosed by a thermoplastic sealing member.

Although several embodiments of the present invention have been described above, these embodiments are presented as examples and are not intended to limit the scope of the invention. These embodiments may be implemented in various other forms, and various omissions, substitutions, and modifications may be made without departing from the spirit of the invention. These embodiments and their modifications fall within the scope and spirit of the invention and are included within the scope of the invention described in the claims and their equivalents.

What is claimed is:

1. A switch device, comprising: an operating member having an operating portion for a push-in operation and a placement portion on which a movable contact is placed; a housing accommodating the placement portion of the operating member and having a through hole through which the operating portion of the operating member is exposed; a return member configured to return the operating member to its original position; a plurality of fixed contacts fixed in the housing; and the movable contact provided on the placement portion of the operating member, a conduction state between the movable contact and the plurality of fixed contacts being switched by movement of the operating member, wherein
each of the plurality of fixed contacts has a conduction portion accommodated in the housing and a plurality of external terminals exposed from the housing; and
a waterproof platform is provided on a bottom surface side of the housing opposite to the operating portion so as to enclose roots of the plurality of external terminals and protrude in a direction away from the operating portion along an extending direction of the external terminals.

2. The switch device according to claim 1, wherein
the waterproof platform comprises:
a plurality of anchor portions that are provided at positions corresponding to the plurality of external terminals on the bottom surface side of the housing and protrude in the direction away from the operating portion so as to enclose an outer periphery of each of the plurality of external terminals.

3. The switch device according to claim 1, wherein
the waterproof platform comprises:
a stepped portion that is provided on the bottom surface side of the housing and protrudes in the direction away from the operating portion so as to cover a central portion of an outer bottom surface of the housing and enclose the roots of the external terminals; and
a plurality of anchor portions that are provided at positions corresponding to the plurality of external terminals and protrude from the stepped portion in the direction away from the operating portion so as to enclose an outer periphery of each of the plurality of external terminals.

4. The switch device according to claim 2, wherein
the waterproof platform further comprises a blocking portion provided between the plurality of anchor portions, and the blocking portion protrudes in the direction away from the operating portion along the extending direction of the external terminals.

5. The switch device according to claim 2, wherein each of the plurality of anchor portions is formed with a plurality of sections along the extending direction of the external terminals, and each of the plurality of anchor portions has a middle section with a cross-sectional area smaller than that of each of two end sections of the plurality of anchor portions along a planar direction parallel to the bottom surface of the housing.

6. The switch device according to claim 4, wherein the blocking portion is formed with a plurality of sections along the extending direction of the external terminals, and the blocking portion has a middle section with a cross-sectional area smaller than that of each of two end sections of the blocking portion along a planar direction parallel to the bottom surface of the housing.

7. The switch device according to claim 4, wherein
a bottom-surface area of the housing is greater than that of the stepped portion, and the bottom-surface area of the stepped portion is greater than those of the anchor portions and the blocking portion.

8. The switch device according to claim 1, wherein
the housing comprises a frame body having an opening at a lower side and a bottom plate fitted to the opening; the plurality of fixed contacts are integrally fixed to the bottom plate by insert molding; and the bottom plate and the waterproof platform are formed from a same resin material.

9. The switch device according to claim 1, wherein
the housing comprises a frame body having an opening at an upper side and a cover plate fitted to the opening; the plurality of fixed contacts are integrally fixed to the frame body by insert molding; and the frame body and the waterproof platform are formed from a same resin material.

10. The switch device according to claim 1, wherein
three switch devices are arranged in parallel; the external terminals of each switch device output, via a shared wiring substrate, detection signals indicating switching of the conduction state externally; and the waterproof platform, the external terminals, and the shared wiring substrate are enclosed by a thermoplastic molded sealing member.

11. A switch module comprising:
three switch devices according Claim 1 arranged in parallel, wherein
the external terminals of each switch device output, via a shared wiring substrate, detection signals indicating switching of the conduction state externally; and the waterproof platform, the external terminals, and the shared wiring substrate are enclosed by a thermoplastic molded sealing member.
